(19) United States
(12) Patent Application Publication
(10) Pub. No.: US 2009/0228526 A1
(43) Pub. Date: Sep. 10, 2009

(54) APPARATUS FOR MANAGING ATTRIBUTE INFORMATION ON SYSTEM RESOURCES

(75) Inventors: Yuji Wada, Kawasaki (JP); Masazumi Matsubara, Kawasaki (JP); Kenji Morimoto, Kawasaki (JP); Yasuhide Matsumoto, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/365,742

(22) Filed: Feb. 4, 2009

(30) Foreign Application Priority Data
Mar. 10, 2008 (JP) 2008-059528

(51) Int. Cl. G06F 17/30

(52) U.S. Cl. 707/201; 707/E17.009

(57) ABSTRACT

An apparatus for managing attribute information on a resource constituting a system includes a first reconciler that reconciles attribute information on the same resource based on a first determination criterion which is a predetermined criterion for reconciling the attribute information on the same resource. A first manager manages, so as to be associated with one another, the attribute information on the same resource, the first determination criterion for reconciling the attribute information, and the reconciled attribute information of the attribute information. A first updater reconciles the attribute information on the same resource based on the first determination criterion associated with the attribute information when the attribute information, on the same resource, with which the reconciled attribute information is associated, is updated.

### CROSS-REFERENCE TO RELATED APPLICATIONS

This application is based upon and claims the benefit of priority of the prior Japanese Patent Application No. 2008-059528, filed on Mar. 10, 2008, the entire contents of which are incorporated herein by reference.

### FIELD

The embodiments discussed herein are related to an apparatus for managing attribute information on resources constituting a system, a medium recording an information processing program, and an information processing method.

### BACKGROUND

A database called F-CMDB (Federated Configuration Management Database) is known. This is a database that manages all the information on the components on an information system by virtually integrating different kinds of databases that manage information on hardware and software constituting the information system.

As shown in FIG. 1, the F-CMDB enables search across a configuration information DB, an incident information DB, a trouble information DB, a resource information DB, a change information DB, and an application information DB which are the virtually integrated databases. These integrated databases each manage CIs (configuration items) which are attribute information on the resources (devices, software, etc.) constituting the system and the inter-information relationship.

As shown in FIG. 2, the F-CMDB has the reconciliation function of arbitrating information by unifying the names of information on the same item managed with different names and different local IDs by the virtually integrated databases, and managing the information with a unique ID that can be used in common by all the virtually integrated databases.

Japanese Laid-open Patent Publication No. 2007-102300 discloses a product data management system that virtually integrates some pieces of product data used in a plurality of processes by a predetermined process flow to manage them.

However, in the above-described F-CMDB, when a CI on which F-CMDB information that is reconciled information is changed, it is necessary to reconcile all the CIs. For example, as shown in FIG. 3, when a CI is deleted, it is necessary for the F-CMDB to perform update by performing reconciliation with reference to all the CIs, which is very inefficient.

### SUMMARY

According to an aspect of an embodiment of the invention, an apparatus for managing attribute information on a resource constituting a system includes a first reconciler that reconciles attribute information on the same resource based on a first determination criterion which is a predetermined criterion for reconciling the attribute information on the same resource; a first manager that manages, so as to be associated with one another, the attribute information on the same resource, the first determination criterion for reconciling the attribute information, and the reconciled attribute information of the attribute information; and a first updater that reconciles the attribute information on the same resource based on the first determination criterion associated with the attribute information when the attribute information, on the same resource, with which the reconciled attribute information is associated is updated.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a view showing the F-CMDB;

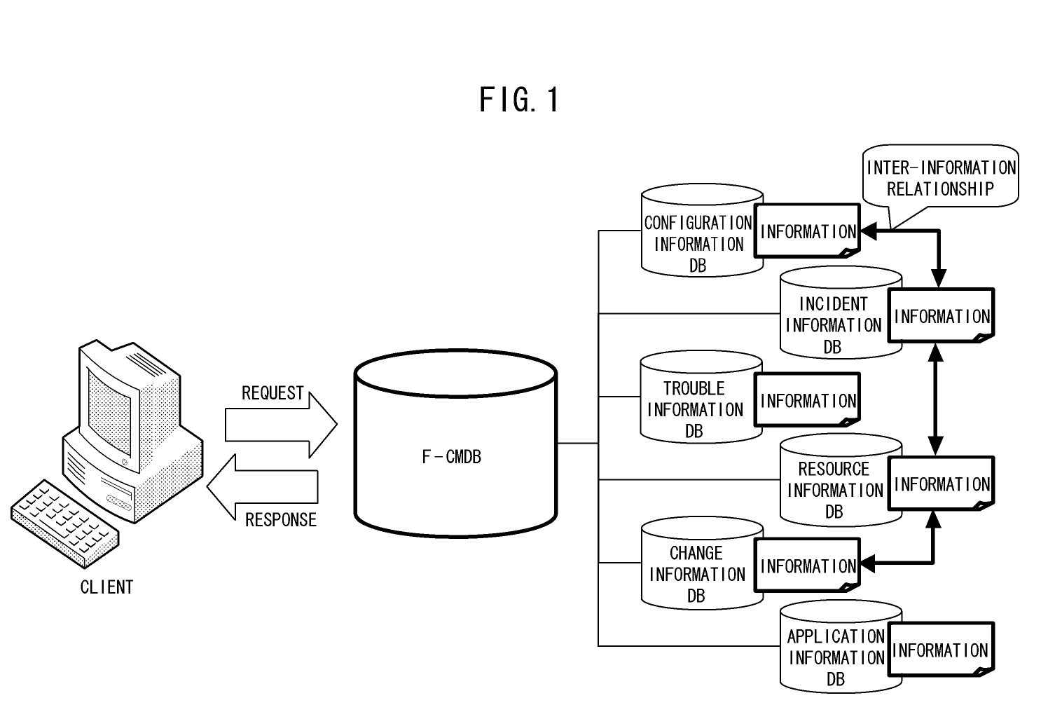

FIG. 2 is a view showing the reconciliation function;

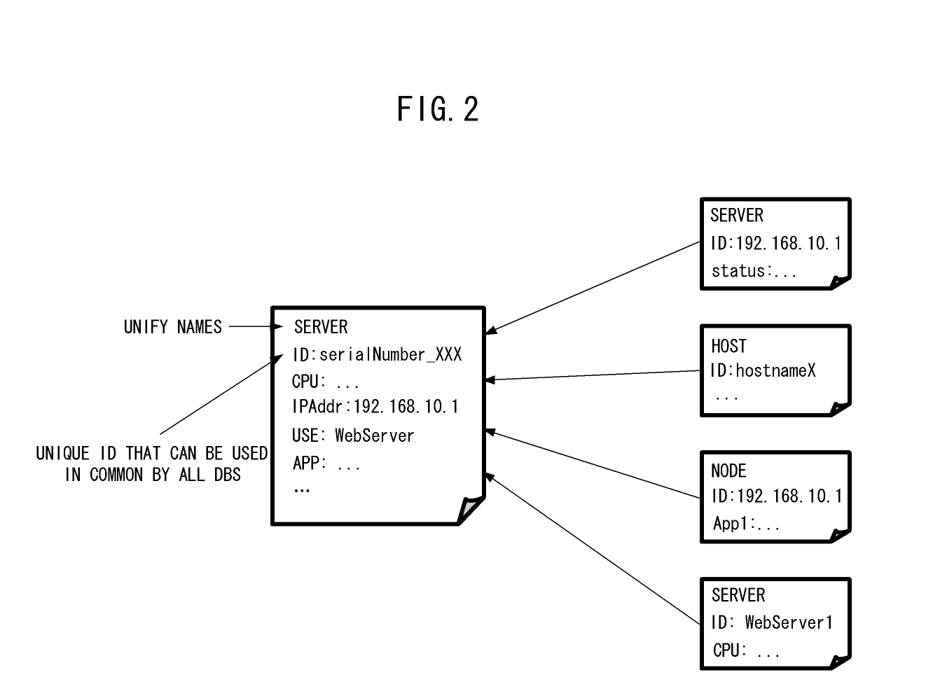

FIG. 3 is a view showing the problem of the conventional reconciliation function;

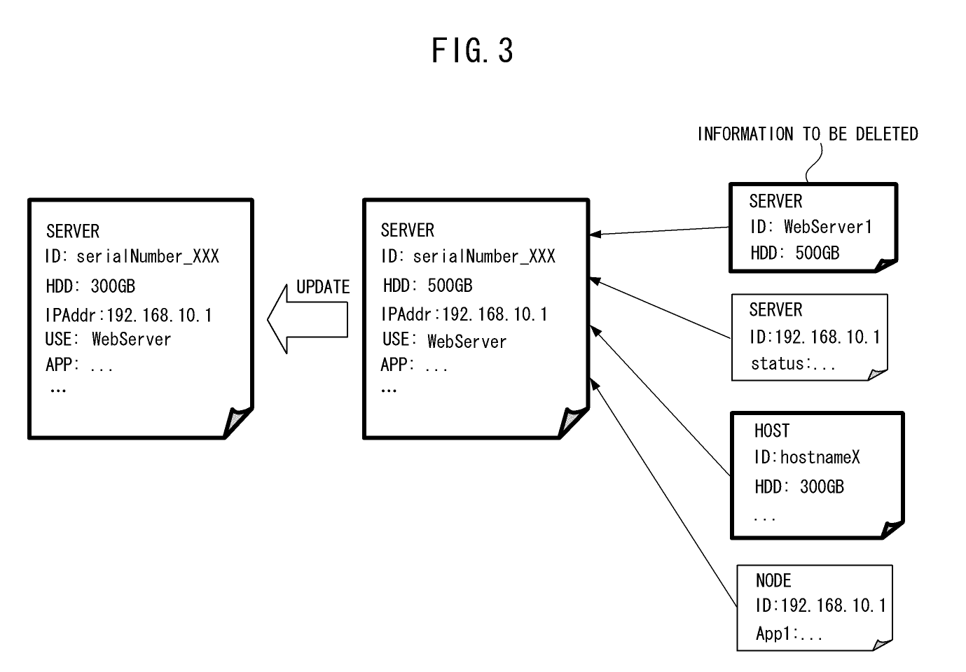

FIG. 4 is a block diagram showing the structure of an F-CMDB according to the present embodiment;

FIG. 5 is a view showing entity meta-information;

FIG. 6 is a view showing property meta-information;

FIG. 7 is a view showing the property meta-information to which reconciliation hints are added;

FIG. 8 is a view showing the general outline of an entity determination processing;

FIG. 9 is a flowchart showing the operation of the entity determination processing;

FIG. 10 is a view showing the general outline of a property determination processing;

FIG. 11 is a flowchart showing the operation of the property determination processing; and

FIG. 12 is a flowchart showing the operation of the property determination processing when the reconciliation hints are used.

### DESCRIPTION OF EMBODIMENTS

Hereinafter, the present embodiment will be described with reference to the drawings

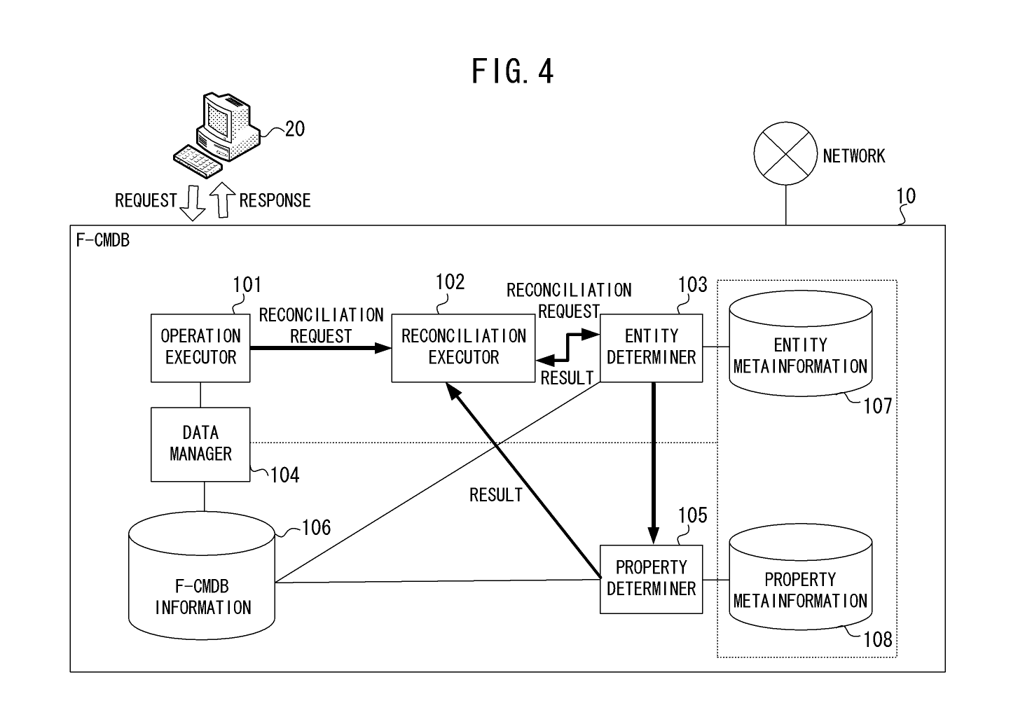

First, the structure of an F-CMDB according to the present embodiment will be described. FIG. 4 is a block diagram showing the structure of the F-CMDB according to the present embodiment.

The F-CMDB 10 has an operation executor 101, a reconciliation executor 102, an entity determiner 103 (the first reconciler, the first manager, and the first updater) a data manager 104 (the first manager and the second manager) and a property determiner 105 (the second reconciler, the second manager, and the second updater).

The F-CMDB 10 is connected to a plurality of non-illustrated databases that manage information on the resources constituting a system through a network, and integrates the information on the same resource managed with different local IDs by these databases.

A terminal 20 requests F-CMDB information 106 which is information on the system reconciled and configuration-managed by the F-CMDB 10.

The operation executor 101 receives a request to update the information on the resources from the connected databases, requests the reconciliation executor 102 to perform reconciliation, and requests the entity determiner 103 to perform reconciliation.

The entity determiner 103 identifies the CI (attribute information) based on the information to be updated, by an entity determination processing described later.

The data manager 104 manages the F-CMDB information 106, entity meta-information 107, and property meta-information 108.

The property determiner 105 identifies the properties (information and parameters constituting the CI such as HDD or Memory) of the CI based on the information to be updated, by a property determination processing described later.

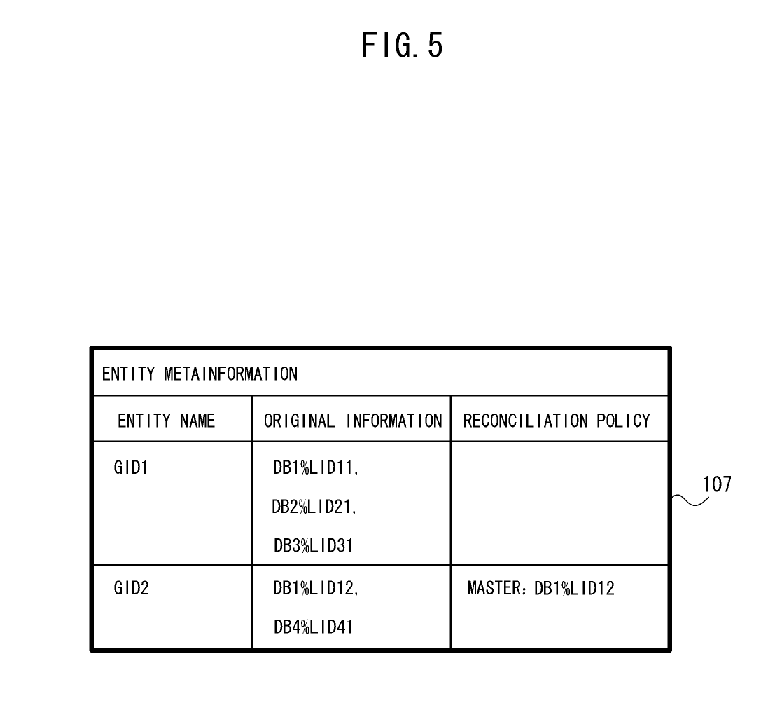

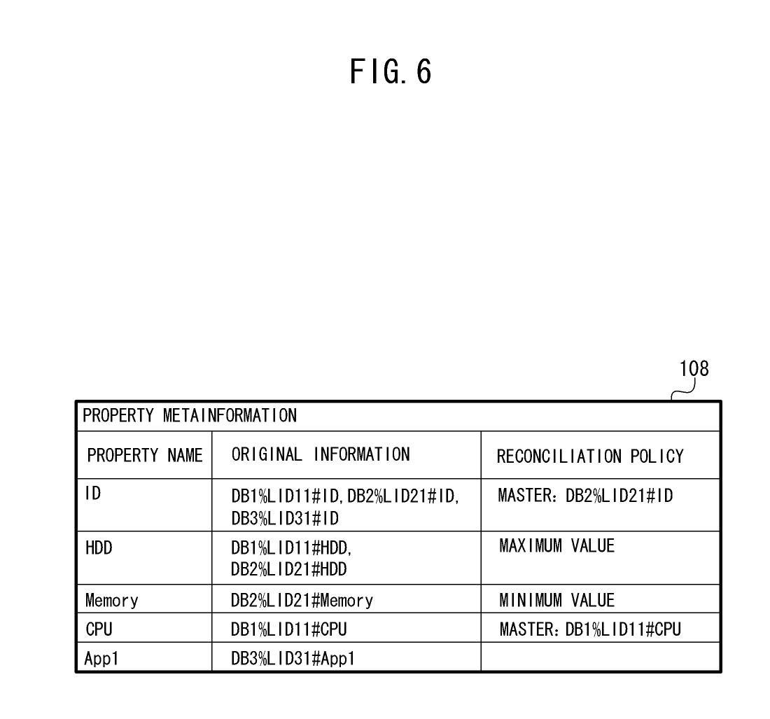

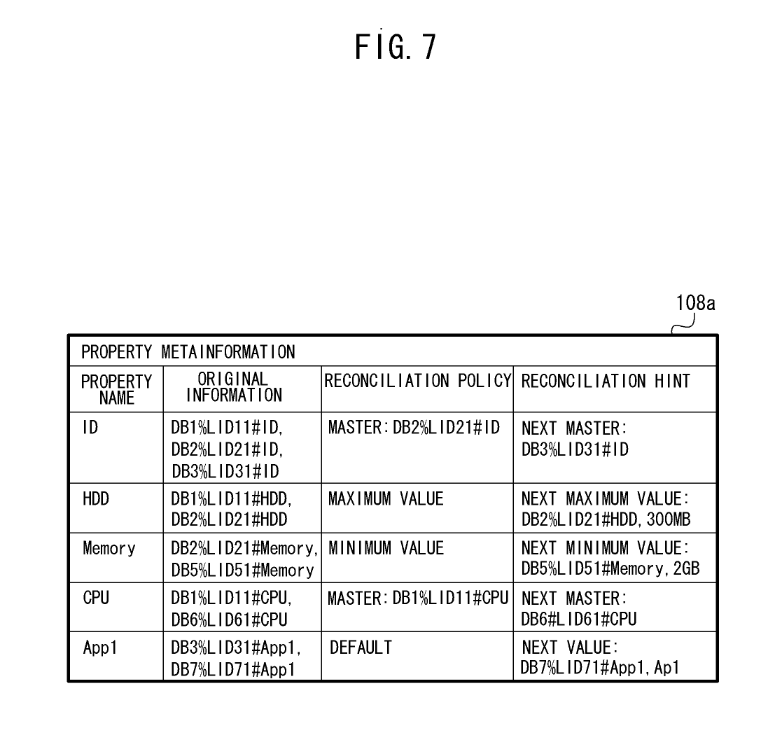

Next, the entity meta-information and the property meta-information will be described. FIG. 5 is a view showing the entity meta-information. FIG. 6 is a view showing the property meta-information. FIG. 7 is a view showing the property meta-information to which reconciliation hints are added.

The entity meta-information 107 is information referred to by the entity determiner 103 when it performs the entity determination processing. In the entity meta-information 107, as shown in FIG. 5, the global ID (GID) as the entity name, the original information which is the location of the information on which the CI represented by the global ID is based, and the reconciliation policy described later are associated with one another.

The F-CMDB information 106 includes the caches of the CIs updated by the connected databases, a plurality of CIs reconciled by the reconciliation function, and the relationship. In the description that follows, reconciled CIs will be referred to as global CIs, and the CIs in the databases will be referred to as local CIs.

The property meta-information 108 is information referred to by the property determiner 105 when it performs the property determination processing. In the property meta-information 108, as shown in FIG. 6, various properties such as ID, HDD, and Memory as the property name, the original information which is the location of the information on which each property is based, and the reconciliation policy are associated with one another.

Now, the reconciliation policy will be described. The reconciliation policy is a rule for determining the information regarded as correct, from among a plurality of CIs when there is more than one CI that is to be referred to at the time of reconciliation. For example, in FIG. 5, when “MASTER:DB1%LID12” which is the reconciliation policy (the first determination criterion) set for GID2 is complied with, LID 11 in DB 1 and LID 41 in DB 4, which are CIs related to a certain same resource A, comply with the set reconciliation policy, and LID 12 in DB 1 is regarded as the CI related to the resource A in the F-CMDB 10. Moreover, in FIG. 6, when a parameter constituting the CI, for example, “MAXIMUM VALUE” which is the reconciliation policy (the second determination criterion) set for HDD is complied with, the highest value of HDD is selected from HDD of LID 11 in DB 1 and HDD of LID 21 in DB 2, which are information on the HDD capacity of the certain same resource A, and this is regarded as the HDD capacity of the resource A in the F-CMDB 10.

While the number of reconciliation policies is one in the property meta-information 108 shown in FIG. 6, more than one policy may be provided as reconciliation hints (the quasi-reconciled parameters) as in property meta-information 108a shown in FIG. 7. The reconciliation hints are spare reconciliation policies used when the property cannot be determined by the reconciliation policy, and reconciliation hints as many as the number of pieces of original information may be provided.

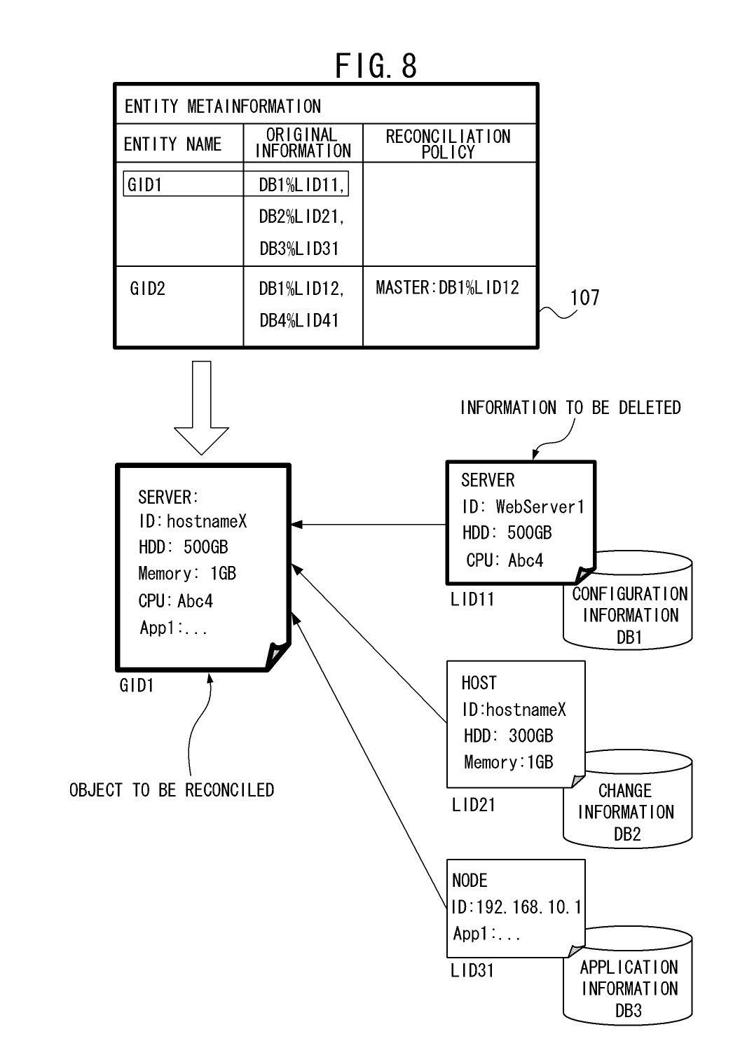

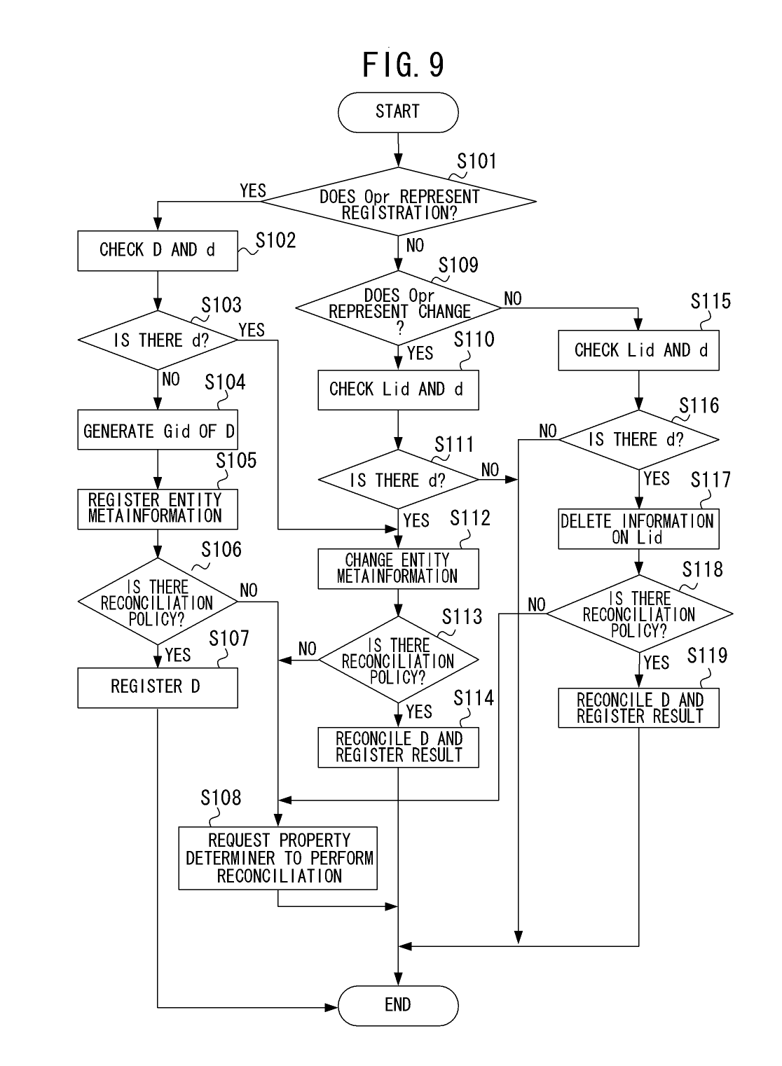

Next, the operation of the F-CMDB according to the present embodiment will be described. FIG. 8 is a view showing the general outline of the entity determination processing. FIG. 9 is a flowchart showing the operation of the entity determination processing. In FIG. 9, it is assumed that the F-CMDB has had a local CI updated by any of the connected databases and has requested the reconciliation executor to perform reconciliation. It is also assumed that the entity determiner has already received a reconciliation request from the reconciliation executor, and Opr is a variable representing whether the reconciliation request is registration, change, or deletion of information. While this variable is represented by a certain value, in FIG. 8, it represents registration, change, or deletion for convenience of explanation. LID represents the local ID, GID represents the global ID, D represents the global CI based on the changed local CI, and d represents all the local CIs on which D is based.

As shown in FIG. 8, the entity determiner 103 refers to the entity meta-information 107 when the local CI on which a global CI (GID 1 in FIG. 8) is based is changed or deleted. Then, the entity determiner 103 checks the local CI related to the same resource as that to which the global CI to be updated is related, and the global CI, and when a reconciliation policy is set for the global CI, the entity determiner 103 performs reconciliation based on the local CI related to the same resource as that to which the updated local CI is related, and updates the global CI.

When in this processing, no reconciliation policy is set for the global CI to be updated, properties are determined based on the reconciliation policy set for each property of the global CI by the property determination processing described later.

When the local CI related to a new resource is registered, based on the registered local CI, the entity determiner 103 generates a global ID, registers the entity meta-information, and generates a global CI.

Hereinafter, the operation of the entity determination processing will be described with reference to the flowchart of FIG. 9.

First, the entity determiner 103 determines whether Opr represents registration or not (S101).

When Opr represents registration (S101, YES), the entity determiner 103 checks D and d related to the same resource as that to which the registered local CI is related (S102), and determines whether there is even one d or not with reference to the entity meta-information 107 (S103).

When there is no d (S103, NO), since there is no D which is the global CI based on d, either, the entity determiner 103 newly generates the global ID (GID) of D (S104). Then, the entity determiner 103 registers the entity meta-information 107 of D based on the generated global ID, the registered local CI, and the reconciliation policy (S105, the first management step). Here, it is assumed that the reconciliation policy on which the entity meta-information 107 is based has been previously added to the local CI as required at the time of registration. Moreover, setting may be made at the entity determiner 103 so that a predetermined reconciliation policy is added by the registered local CI satisfying a predetermined condition. It is not essential that this reconciliation policy be added or set.

Then, the entity determiner 103 determines whether there is a reconciliation policy corresponding to D in the entity meta-information 107 or not (S106).

When there is a reconciliation policy corresponding to D (S106, YES, the reconciliation step), the entity determiner 103 registers D in the F-CMDB information 106 as a global CI (S107, the reconciliation step).

On the other hand, when there is no reconciliation policy in the registered entity meta-information 107 (S106, NO), the entity determiner 103 requests the property determiner 105 to perform reconciliation (S108).

At step S103, when there is even one d (S103, YES), since there is also D which is the global CI based on d, the entity determiner 103 performs not registration but change necessarily, and performs the processing of step S112 described later.

At step S101, when Opr does not represent registration (S101), the entity determiner 103 determines whether Opr represents change or not (S109).

When Opr represents change (S109, YES), with reference to the entity meta-information 107, with the local ID (LID) of the changed local CI as the argument, the entity determiner 103 checks d, which is the CI related to the same resource as that to which the local CI is related (S110), and determines whether there is even one d or not (S111).

When there is even one d (S111, YES), the entity determiner 103 changes, in the entity meta-information 107, the reconciliation policy of the entity meta-information corresponding to the global ID of D based on the changed local CI and the reconciliation policy added to the reconciliation request (S112, the first management step). It is not essential that the reconciliation policy be added to the reconciliation request. The reconciliation policy may be preset.

Then, the entity determiner 103 determines whether there is a reconciliation policy corresponding to the changed local CI or not (S113).

When there is a reconciliation policy corresponding to the changed local CI (S113, YES, the reconciliation step), the entity determiner 103 overwrites, of d prestored in the F-CMDB information 106 as caches, the changed local CI, reconciles D based on the changed d, and registers the result in the F-CMDB 106 (S114, the reconciliation step and the update step).

On the other hand, when there is no reconciliation policy corresponding to the changed local CI (S113, NO), the entity determiner 103 requests the property determiner 105 to perform reconciliation (S108).

At step S111, when there is no d (S111, NO), the entity determiner 103 ends the processing.

At step S109, when Opr does not represents change (S109, NO), that is, when Opr represents deletion, with reference to the entity meta-information 107, with the local ID (LID) of the deleted local CI as the argument, the entity determiner 103 checks d, which is the CI related to the same resource as that to which the local CI is related (S115), and determines whether there is even one d or not (S116).

When there is even one d (S116, YES), the entity determiner 103 deletes the information on the local ID (LID) of the deleted local CI from the entity meta-information 107 (S117, the management step), and determines whether there is a reconciliation policy corresponding to d or not (S118).

When there is a reconciliation policy corresponding to d (S118, YES, the reconciliation step), the entity determiner 103 reconciles D from d except the deleted local CI based on the reconciliation policy, and registers the reconciled D in the F-CMDB information 106 (S119, the reconciliation step and the update step).

On the other hand, when there is no reconciliation policy corresponding to d (S118, NO), the entity determiner 103 requests the property determiner 105 to perform reconciliation (S108).

At step S116, when there is no d (S116, NO), the entity determiner 103 ends the processing.

While registration, change, and deletion of the local CI are described in the flowchart of FIG. 9, it is assumed that when a local CI is added, the same processing (step S110 and subsequent steps) as that of change is performed except for step S112, and the entity meta-information is added at step S112.

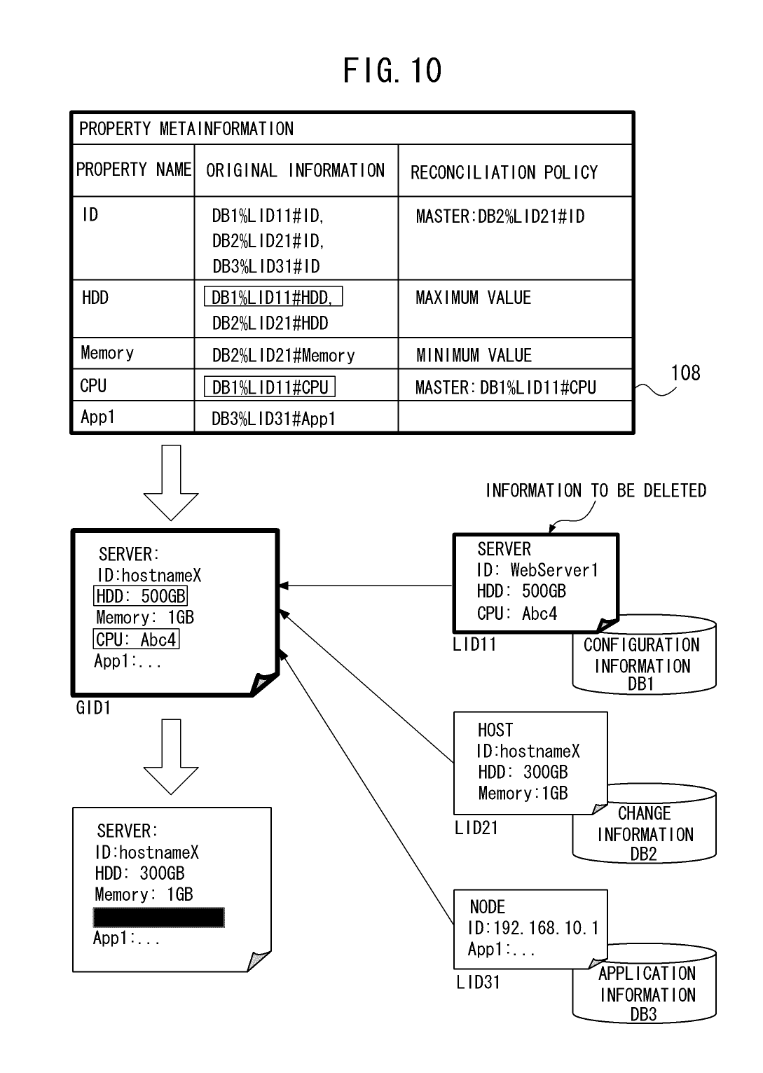

Next, the property determination processing will be described. FIG. 10 is a view showing the general outline of the property determination processing.

As shown in FIG. 10, the property determiner 105 updates only the property that exerts an influence in the following cases according to the reconciliation policy:

when the local CI based on the global CI has been registered, changed, or updated; and

when in the entity meta-information 107, no reconciliation policy is set for the global CI and the property changed in the updated local CI affects the global CI.

An example in which the local ID 11 is deleted as shown in FIG. 10 will be described.

Of the properties of the local CI, HDD and CPU take the values of the global ID 1 according to the reconciliation policy. Therefore, HDD and CPU are to be updated, and the value of HDD of the global ID 1 is, as maximum value, 300 G, which is the value of HDD of the local ID21, and as for the value of CPU, since there is no other value based thereon, the value of CPU of the global ID 1 is deleted.

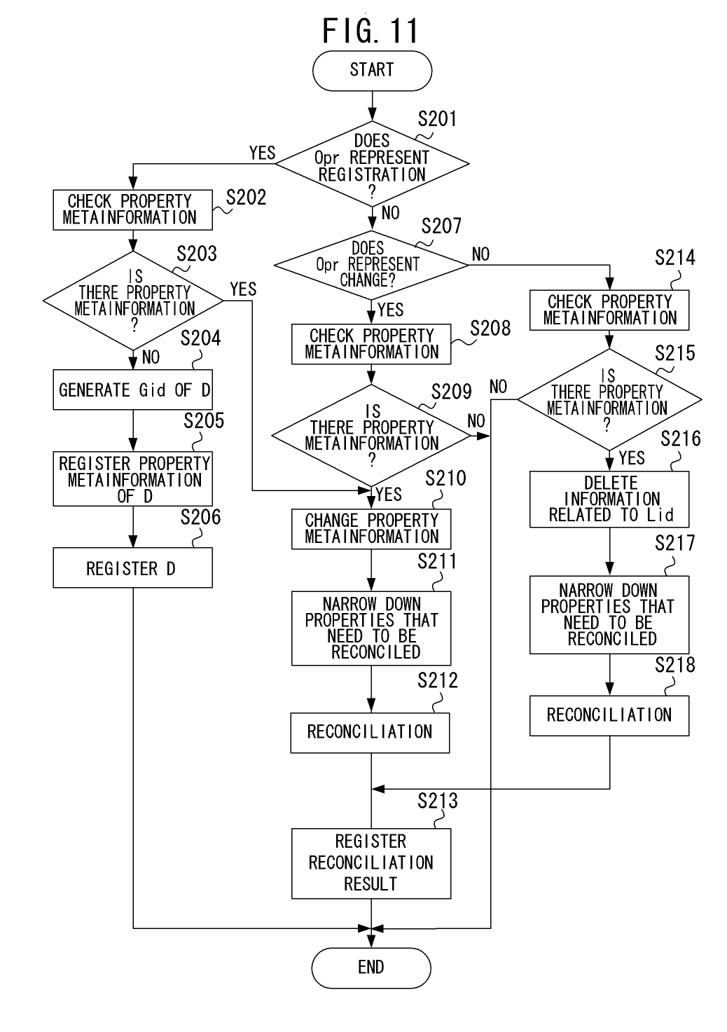

FIG. 11 is a flowchart showing the operation of the property determination processing.

Hereinafter, the operation of the property determination processing will be described with reference to the flowchart of FIG. 11. In this figure, it is assumed that the property determiner has already received a reconciliation request from the entity determiner. That is, this is the operation of the property determiner subsequent to step S108 in FIG. 9. In this figure, Opr is a variable representing whether the reconciliation request is registration, change, or deletion of information, LID represents the local ID, GID represents the global ID, D represents the global CI based on a changed local CI, and d represents all the CIs on which D is based.

First, the property determiner 105 determines whether Opr represents registration or not (S201).

When Opr represents registration (S201, YES), with reference to all the property meta-information 108, the property determiner 105 checks the property meta-information 108 corresponding to the global ID of D (S202), and determines whether there is property meta-information 108 corresponding to the global ID of D or not (S203).

When there is no property meta-information corresponding to the global ID of D (S203, NO), the property determiner 105 generates the global ID (GID) of D (S204) registers the property meta-information 108 of D (S205, the second management step), and registers D in the F-CMDB information 106 (S206, the second reconciliation step).

On the other hand, when there is property meta-information corresponding to the global ID of D (S203, YES), since there is also D, the property determiner 105 necessarily performs not registration but change, and performs the processing of step S210 described later.

At the determination of step S201, when Opr does not represent registration (S201, NO), the property determiner 105 determines whether Opr represents change or not (S207).

When Opr represents change (S207, YES), with reference to all the property meta-information 108, the property determiner 105 checks the property meta-information 108 corresponding to the global ID of D (S208), and determines whether there is property meta-information 108 corresponding to the global ID of D or not (S209).

When there is property meta-information 108 corresponding to the global ID of D (S209, YES), the property determiner 105 changes, in the property meta-information 108, the reconciliation policy of the property meta-information corresponding to each property of D based on the local ID of the changed local CI and the reconciliation policy added to the reconciliation request (S210, the management step). It is not essential that the reconciliation policy be added to the reconciliation request.

Then, the property determiner 105 narrows down the properties of D that need to be reconciled because of the change of the local CI (S211), performs reconciliation (S212, the reconciliation step and the update step), and registers the result of the reconciliation in the F-CMDB information 106 (S213).

At the determination of step S209, when there is no property meta-information 108 corresponding to the global ID of D (S209, NO), the property determiner 105 ends the processing.

At the determination of step S207, when Opr does not represent change (S207, NO), that is, when Opr represents deletion, with reference to all the property meta-information 108, the property determiner 105 checks the property meta-information 108 corresponding to the global ID of D (S214) and determines whether there is property meta-information 108 corresponding to the global ID of D or not (S215).

When there is property meta-information 108 corresponding to the global ID of D (S215, YES), the property determiner 105 deletes the information related to the local ID (LID) of the deleted local CI (S216, the management step) narrows down the properties that need to be reconciled because of the deletion of the information (S217), performs reconciliation (S218, the reconciliation step and the update step), and registers the result of the reconciliation in the F-CMDB information 106 (S213).

On the other hand, when there is no property meta-information 108 corresponding to the global ID of D (S215, NO), the property determiner 105 ends the processing.

As described above, when the local CI is updated, only the global CI that needs to be reconciled can be reconciled by the entity determination processing. Further, only the property of the global CI that needs to be reconciled can be reconciled by the property determination processing. Moreover, by using the reconciliation policy in the reconciliation, the reconciliation policy can be made a criterion for determining the global CI or the parameters of the global CI from a plurality of local CIs related to the same resource.

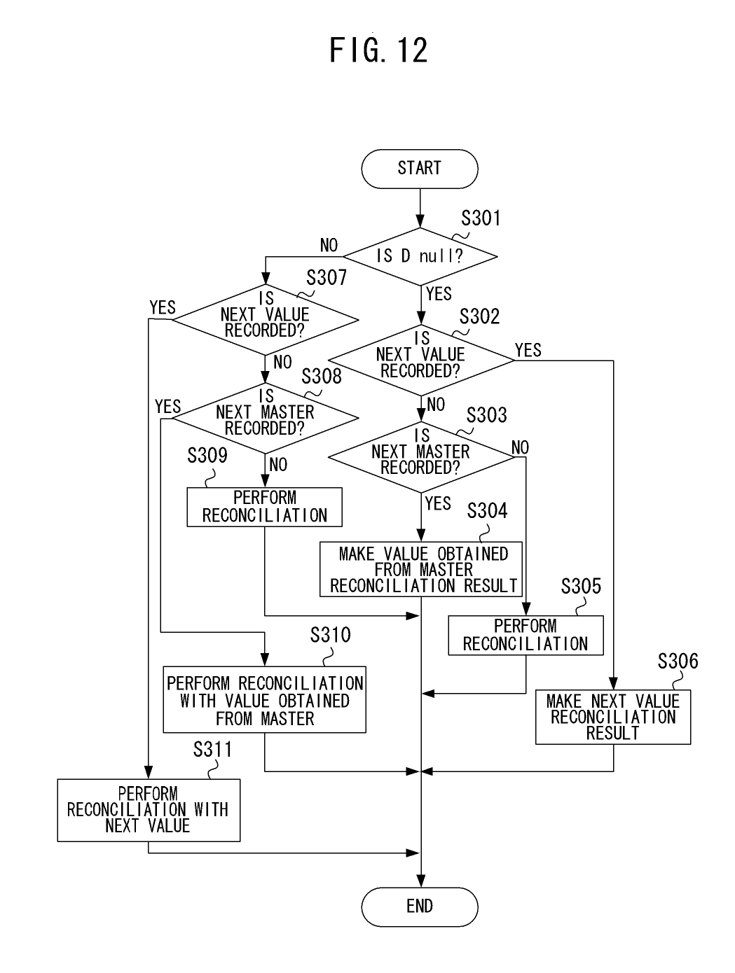

Next, the property determination processing shown in FIG. 7 when reconciliation hints in the property meta-information are used will be described. FIG. 12 is a flowchart showing the operation of the property determination processing when the reconciliation hints are used. In this figure, D represents the global CI based on a certain updated local CI, and d represents all the local CIs on which D is based. In this figure, the properties to be reconciled have already been narrowed down, and an operation is shown in which one property is reconciled under a condition where the property of the local CI having been selected by the reconciliation policy is the property of the updated local CI.

First, the property determiner 105 determines whether the property of D is null or not, that is, whether the value of the property is temporarily deleted because of the update of the local CI on which D is based or not (S301).

When the property of D is null (S301, YES), the property determiner 105 determines whether the next value (including the next maximum value and the next minimum value) is recorded in the hint for the reconciliation of the property to be reconciled in the property meta-information 108 of D or not (S302).

When the next value is not recorded in the hint for the reconciliation of the property to be reconciled (S302, NO) the property determiner 105 determines whether the next master is recorded in the hint for the reconciliation of the property to be reconciled or not (S303).

When the next master is recorded in the hint for the reconciliation of the property to be reconciled (S302, YES) the property determiner 105 makes the value obtained from the next master the result of the reconciliation (S304).

On the other hand, when the next master is not recorded in the hint for the reconciliation of the property to be reconciled (S303, NO), the property determiner 105 performs reconciliation based on d (S305).

At the determination of step S302, when the next value is recorded in the hint for the reconciliation of the property to be reconciled (S302, YES), the property determiner 105 makes the next value the result of the reconciliation (S306).

At the determination of step S301, when D is not null (S301, NO), the property determiner 105 determines whether the next value is recorded in the hint for the reconciliation of the property to be reconciled or not (S307).

When the next value is not recorded in the hint for the reconciliation of the property to be reconciled (S307, NO) the property determiner 105 determines whether the next master is recorded in the hint for the reconciliation of the property to be reconciled or not (S308).

When the next master is not recorded in the hint for the reconciliation of the property to be reconciled (S308, NO) the property determiner 105 performs reconciliation based on d (S309).

On the other hand, when the next master is recorded in the hint for the reconciliation of the property to be reconciled (S308, YES), the property determiner 105 performs reconciliation with the next master and the property of the updated local CI (S310).

At the determination of step S307, when the next value is recorded in the hint for the reconciliation of the property to be reconciled (S307, YES), the property determiner 105 performs reconciliation with the next value and the property of the updated local CI (S311).

As described above, by using reconciliation hints whose values are predetermined, for reconciliation, when the property selected by the reconciliation policy is the property of the updated local CI, the reconciliation processing can be efficiently performed. For example, when the reconciliation policy is the maximum value and the property selected by the reconciliation policy is the property of the deleted local CI, the property determiner 105 can make the next maximum value the result of the reconciliation without performing reconciliation again. Even when the local CI is changed, the property of the global CI can be reconciled by comparing the property of the local CI with the next maximum value.

Further, a program to execute the above-described steps in a computer constituting an information processing apparatus can be provided as an information processing program. The above-mentioned program can be executed by the computer constituting the information processing apparatus by storing it in a computer-readable recording medium. Examples of the above-mentioned computer-readable recording medium include: internal storages incorporated in computers such as ROMs and RAMs and Hard Disk; portable storage media such as CD-ROMs, flexible disks, DVD disks, magneto-optical disks, and IC cards; databases holding computer programs.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. An apparatus for managing attribute information on a resource constituting a system, comprising:
a first reconciler that reconciles attribute information on the same resource based on a first determination criterion which is a predetermined criterion for reconciling the attribute information on the same resource;
a first manager that manages, so as to be associated with one another, the attribute information on the same resource, the first determination criterion for reconciling the attribute information, and the reconciled attribute information of the attribute information; and
a first updater that reconciles the attribute information on the same resource based on the first determination criterion associated with the attribute information when the attribute information, on the same resource, with which the reconciled attribute information is associated is updated.

2. The apparatus according to claim 1, wherein
the attribute information includes at least one parameter, and
the apparatus further comprising:
a second reconciler that reconciles a parameter of the attribute information on the same resource based on a second determination criterion which is a predetermined criterion for reconciling the parameter of the attribute information on the same resource;
a second manager that manages, so as to be associated with one another, the parameter of the attribute information on the same resource, the second determination criterion for reconciling the parameter, and the reconciled parameter of the parameter; and
a second updater that reconciles the parameter of the attribute information on the same resource based on the second determination criterion associated with the parameter when the parameter of the attribute information, on the same resource, with which the reconciled parameter is associated is updated.

3. The information processing apparatus according to claim 2, wherein
the second determination criterion represents a predetermined parameter or a predetermined statistic of predetermined attribute information,
the second reconciler selects a parameter from the parameter of the attribute information on the same resource or calculates the statistic based on the second determination criterion, and
the second updater selects an additional parameter of the parameter of the attribute information on the same resource or calculates the statistic based on the second determination criterion.

4. The information processing apparatus according to claim 2, wherein
when the second determination criterion represents a parameter of predetermined attribute information, as a quasi-reconciled parameter, the second updater selects a parameter except the parameter selected based on the second determination criterion by the second reconciler.

5. The information processing apparatus according to claim 2, wherein
when the second determination criterion represents a predetermined statistic and the statistic is an extreme value, the second updater calculates, as a quasi-reconciled parameter, an extreme value next to an extreme value calculated as the reconciled parameter.

6. The information processing apparatus according to claim 1, wherein
the first determination criterion represents predetermined attribute information,
the first reconciler selects a piece of attribute information from the attribute information on the same resource based on the first determination criterion, and
the first updater selects a piece of attribute information from the attribute information, on the same resource, with which the reconciled attribute information is associated based on the first determination criterion.

7. A recording medium recording an information processing program causing a computer to execute a process comprising:
reconciling attribute information on the same resource based on a first determination criterion which is a predetermined criterion for reconciling the attribute information on the same resource;
managing, so as to be associated with one another, the attribute information on the same resource, the first determination criterion for reconciling the attribute information, and the reconciled attribute information of the attribute information; and
reconciling the attribute information on the same resource based on the first determination criterion associated with the attribute information when the attribute information, on the same resource, associated with the reconciled attribute information is updated.

8. The recording medium recording an information processing program according to claim 7, wherein
the attribute information includes at least one parameter, and
the process further comprising:
reconciling a parameter of the attribute information on the same resource based on a second determination criterion which is a predetermined criterion for reconciling the parameter of the attribute information on the same resource;
managing, so as to be associated with one another, the parameter of the attribute information on the same resource, the second determination criterion for reconciling the parameter, and the reconciled parameter of the parameter; and
reconciling the parameter of the attribute information on the same resource based on the second determination criterion associated with the parameter when the parameter of the attribute information, on the same resource with which the reconciled parameter is associated, is updated.

9. The recording medium recording an information processing program according to claim 8, wherein
the second determination criterion represents a predetermined parameter or a predetermined statistic of predetermined attribute information, and
in the reconciliation, a parameter is selected from the parameter of the attribute information on the same resource or the statistic is calculated based on the second determination criterion.

10. The recording medium recording an information processing program according to claim 8, wherein
when the second determination criterion represents a parameter of predetermined attribute information, in the second parameter reconciliation, a parameter except the parameter selected based on the second determination criterion by the first parameter reconciliation is selected as a quasi-reconciled parameter.

11. The recording medium recording an information processing program according to claim 8, wherein
when the second determination criterion represents a predetermined statistic and the statistic is an extreme value, in the second reconciliation, an extreme value next to an extreme value calculated as the reconciled parameter is calculated as a quasi-reconciled parameter.

12. The recording medium recording an information processing program according to claim 8, wherein
the first determination criterion represents predetermined attribute information, in the first reconciliation step, a piece of attribute information is selected from the attribute information on the same resource based on the first determination criterion, and in the first update step, a piece of attribute information is selected from the attribute information on which the reconciled attribute information is based, based on the first determination criterion.

13. An information processing method of managing attribute information on a resource constituting a system, comprising:
reconciling attribute information on the same resource based on a first determination criterion which is a predetermined criterion for reconciling the attribute information on the same resource;
managing, so as to be associated with one another, the attribute information on the same resource, the first determination criterion for reconciling the attribute information, and the reconciled attribute information of the attribute information; and
reconciling the attribute information on the same resource based on the first determination criterion associated with the attribute information when the attribute information, on the same resource, associated with the reconciled attribute information, is updated.

14. The information processing method according to claim 13, wherein
the attribute information includes at least one parameter, and
the method further comprising:
reconciling a parameter of the attribute information on the same resource based on a second determination criterion which is a predetermined criterion for reconciling the parameter of the attribute information on the same resource;
managing, so as to be associated with one another, the parameter of the attribute information on the same resource, the second determination criterion for reconciling the parameter, and the reconciled parameter of the parameter; and
reconciling the parameter of the attribute information on the same resource based on the second determination criterion associated with the parameter when the parameter of the attribute information, on the same resource, with which the reconciled parameter is associated, is updated.

15. The information processing method according to claim 14, wherein
the second determination criterion represents a predetermined parameter or a predetermined statistic of predetermined attribute information, and
in the reconciliation, a parameter is selected from the parameter of the attribute information on the same resource, or the statistic is calculated based on the second determination criterion.

16. The information processing method according to claim 14, wherein
when the second determination criterion represents a predetermined statistic and the statistic is an extreme value, in the second reconciliation, an extreme value next to an extreme value calculated as the reconciled parameter is calculated as a quasi-reconciled parameter.

17. The information processing method according to claim 14, wherein
when the second determination criterion represents a predetermined statistic and the statistic is an extreme value, in the second update step, an extreme value next to an extreme value calculated as the reconciled parameter is calculated as a quasi-reconciled parameter.

18. The information processing method according to claim 13, wherein
the first determination criterion represents predetermined attribute information, in the first reconciliation step, a piece of attribute information is selected from the attribute information on the same resource based on the first determination criterion, and in the first update step, a piece of attribute information is selected from the attribute information on which the reconciled attribute information is based, based on the first determination criterion.
